(19) United States
(12) Patent Application Publication
(10) Pub. No.: US 2021/0194410 A1
(43) Pub. Date: Jun. 24, 2021

(54) ASSEMBLY APPARATUS FOR TRUSS STRUCTURE

(71) Applicant: JING-XIN SOLAR LTD., TAINAN CITY (TW)

(72) Inventor: Ching-Lung YANG, TAINAN CITY (TW)

(21) Appl. No.: 16/739,503

(22) Filed: Jan. 10, 2020

(30) Foreign Application Priority Data
Dec. 20, 2019 (TW) 108146943

(51) Int. Cl. H02S 20/23; H02S 30/10

(52) U.S. Cl. CPC H02S 20/23; H02S 20/10; H02S 30/10

(57) ABSTRACT

An assembly apparatus for a truss structure includes a supporting column, a holding member and a fastening member. The supporting column includes an attachment portion. The holding member includes a supporting portion and a positioning portion arranged adjacent to the supporting portion. The supporting portion includes a guiding slot opened in a vertical direction, and the guiding slot is configured to receive the trust structure therein. The fastening member is arranged on the positioning portion of the holding member and the attachment portion of the supporting column. The holding member is movably secured onto the supporting column. With the aforementioned assembly, the present invention is able to provide a convenient and assembly-facilitated truss structure for the installation of photovoltaic modules while reducing the overall cost.

### BACKGROUND OF THE INVENTION

### 1. Technical Field

The present invention relates to a truss structure, in particular, to an assembly apparatus for a truss structure used in the installation of a photovoltaic module.

### 2. Description of Related Art

Photovoltaic modules are typically installed on roofs of buildings or at open land without any shields in order to allow sunlight to be projected onto the photovoltaic modules at the greatest extend, thereby generating electrical power with economic value while achieving the objectives of environmental friendliness and green energy for environmental protection.

Generally, prior to the installation of photovoltaic modules, it is necessary to use a multiple number of steel beams to assembly into a truss structure, followed by laying all of the photovoltaic modules flatly together. In addition, with the use of sufficient securement method, the entire structure is able to achieve sufficient strength without damages under various different weather conditions.

Nevertheless, the aforementioned relevant components for the assembly of truss structure are of great quantity and complicated parts, causing the assembly method to be difficult, time and labor consuming, and the overall cost is also relatively expensive.

### BRIEF SUMMARY OF THE INVENTION

Accordingly, the primary objective of the present invention is to provide a convenient and facilitated assembly apparatus for a trust structure, such that it is able to achieve faster installation of the truss structure for photovoltaic modules with relatively fewer component parts and lower overall cost.

To achieve the foregoing objective, the present invention provides an assembly apparatus for a truss structure, comprising a supporting column, a holding member and a fastening member. The supporting column includes an attachment portion. The holding member includes a supporting portion and a positioning portion arranged adjacent to the supporting portion. The supporting portion includes a guiding slot opened in a vertical direction, and the guiding slot is configured to receive the trust structure therein. The fastening member is arranged on the positioning portion of the holding member and the attachment portion of the supporting column. The holding member is movably secured onto the supporting column. With the aforementioned assembly, the present invention is able to provide a convenient and assembly-facilitated truss structure for the installation of photovoltaic modules while reducing the overall cost.

Preferably, wherein the supporting column includes a fixation portion; the attachment portion extends from the fixation portion in a vertical direction; the attachment portion includes an elongated through hole, and the fastening member is arranged at the through hole and the positioning portion.

Preferably, wherein the supporting column includes at least two retaining portions; the guiding slot is formed between the at least two retaining portions.

Preferably, wherein an engagement set is arranged between the attachment portion of the supporting column and the positioning portion of the holding member; the engagement set is positioned at the attachment portion of the supporting column and the positioning portion of the holding member.

Preferably, wherein the supporting portion of the holding member extends horizontally at two opposite sides of the positioning portion; the supporting portion includes at least two retaining portions to form the guiding slot, thereby allowing two sides of the supporting portion to be installed and secured with the truss structure thereon.

Preferably, wherein the holding member comprises two locking members; the two locking members are arranged corresponding to each other in order to jointly form the supporting portion and the positioning portion.

Regarding the detailed structure or technical features of the present invention, details are provided in the following accompanied drawings and description. However, a person with ordinary skill in the art in the technical field of the present invention shall understand that such detailed description and the specific embodiments disclosed in the present invention are provided to illustrate the present invention only such that they shall not be treated as limitation of the scope of the claim of the present invention.

### BRIEF DESCRIPTION OF THE SEVERAL VIEWS OF THE DRAWINGS

FIG. 1 is a perspective exploded view of a preferred embodiment of the present invention.

FIG. 2 is a side view of a preferred embodiment of the present invention.

FIG. 3 is a perspective exploded view of another preferred embodiment of the present invention.

FIG. 4 is a perspective assembly view of another preferred embodiment of the present invention.

FIG. 5 is a perspective assembly view of still another preferred embodiment of the present invention.

FIG. 6 is a perspective exploded view of still another preferred embodiment of the present invention.

FIG. 7 is a side view of still another preferred embodiment of the present invention.

### DETAILED DESCRIPTION OF THE INVENTION

The following provides preferred embodiments along with the accompanied drawings to describe the technical content and features of the present invention in detail. A person skilled in the art in this field is able to understand that the description and terms used to describe the embodiments refer to the superordinate descriptions not limited to the application field. For example, the terms of materials or shapes used include but not limited to the specified materials or shapes only. The terms of location positioning include but not limited to being arranged at, adjacent to, connected to or abutted to. The terms of quantity of each element such as “one” includes the quantity of one and more than one of plurality of elements. The directional terms of “up”, “down”, “inner”, “outer”, “top” and “bottom” etc. are descriptive terms as examples for normal direction of use, which shall not be treated as limitations to the scope of the claim.

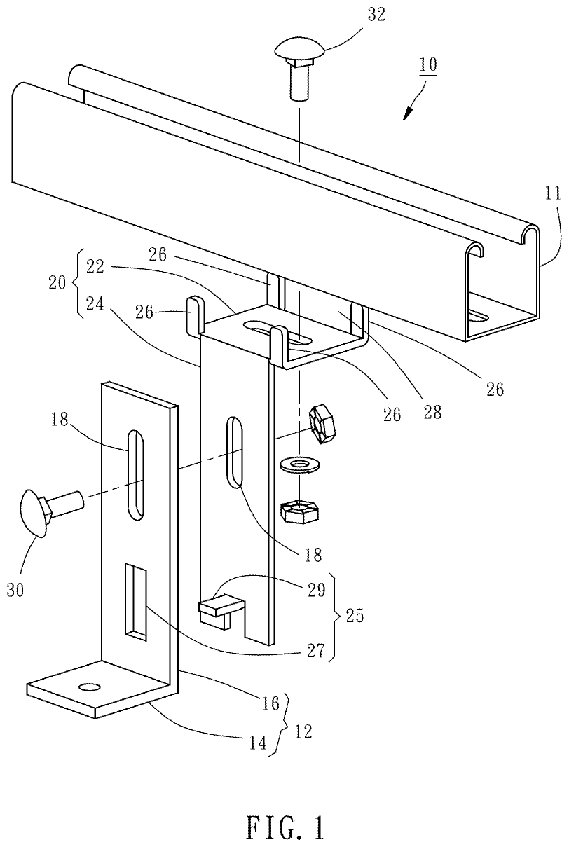

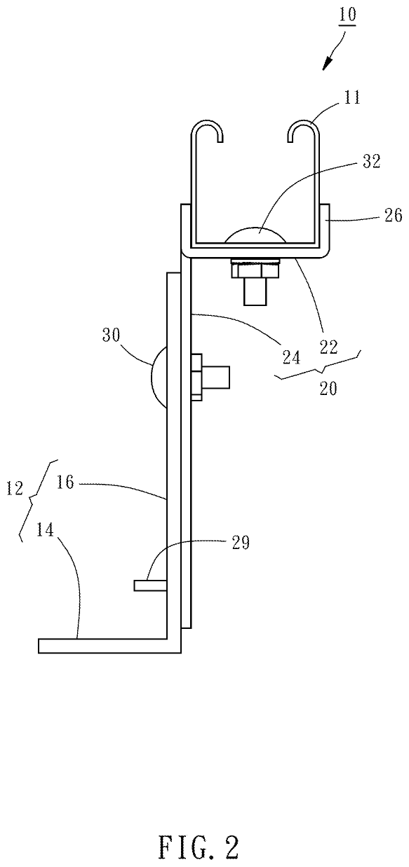

As shown in FIG. 1 to FIG. 2, according to a preferred embodiment of the present invention, an assembly apparatus 10 for a truss structure is provided, comprising a supporting column 12, a holding member 20 and a fastening member 30. In this preferred embodiment, the supporting column 12, the holding member 20 and the fastening member 30 are made of metal plates and formed into shape via stamping process as an example for illustration. The supporting column 12 includes a fixation portion 14 and an attachment portion 16. The attachment portion 16 extends from the bottom end of the fixation portion 14 in a vertical direction toward a lateral side thereof. The attachment portion 16 includes an elongated through hole 18 extended along a vertical direction.

The holding member 20 includes a supporting portion 22 and a positioning portion 24 arranged adjacent to the supporting portion 22. In this preferred embodiment, the supporting portion 22 is a horizontal plate as an example for illustration. The positioning portion 24 extends downward from a side edge of the supporting portion 22 in a vertical direction. Each corner of the supporting portion 22 includes a retaining portion 26 protruded upward therefrom respectively in order to allow the supporting portion 22 to form at least one guiding slot 28 opened in a vertical direction. The guiding slot 28 extends horizontally between the retaining portions 26 and are provided to allow the truss structure 11 to be placed onto the supporting portion 22 downward from the top directly. For example, a steel beam or other frames for photovoltaic modules can be placed onto the supporting portion 22 from the top, followed which screws 32 can be used to secure the truss structure 11 onto the supporting portion 22. The positioning portion 24 also includes an elongated through hole 18 extended in a vertical direction.

In this preferred embodiment, the fastening member 30 uses a screw bolt as an example for illustration. The fastening member 30 penetrates through the through hole 18 of the positioning portion 24 of the holding member 20 and the through hole 18 of the attachment portion 16 of the supporting column 12, such that the holding member 20 and the supporting column 12 can utilize the fastening member 30 or fixation onto each other, and the gap between each of the through holes 18 and the fastening member 30 can be further used to adjust the up/down position between the holding member 20 and the supporting column 12, thereby changing the height of the truss structure 11. It shall be noted that an engagement set 25 is arranged between the attachment portion 16 of the supporting column 12 and the positioning portion 24 of the holding member 20. In this preferred embodiment, the engagement set 25 comprises a through hole 27 arranged at the bottom side of the attachment portion 16 and an extension portion 29 arranged on the positioning portion 24 as an example for illustration. When the attachment portion 16 of the supporting column 12 and the positioning portion 24 of the holding member 20 are assembled onto each other, it is able to use the extension portion 29 to be inserted into the through hole 27 in order to guide the supporting column 12 and the holding member 20 be positioned at the correct positions such that additional operating time is not required to directly secure the fastening member 30.

With the aforementioned assembly apparatus, during the installation of photovoltaic modules, users are only required to directly install the fixation portion 14 of the supporting column 12 onto the ground or roof of the building in order to allow the holding member 20 to be at arranged at a vertical position, thereby allowing the truss structure 11 to be easily placed downward from the top and positioned at the internal of the guiding slot 28 of the supporting portion 22. Consequently, the truss structure 11 and the holding member 20 are attached together to complete the entire assembly step. The present invention only uses two fixation and attachment procedures to complete the assembly of the truss structure 11. In addition, the extension direction of the guiding slot 28 of the holding member 20 can be flexibly adjusted according to the installation method of the retaining portions 26, such that it is able to flexibly cooperate with the actual needs of the installation of the truss structure 11 in the field, thereby achieving convenient and fast assembly as well as achieving the objective of reducing overall cost of the present invention.

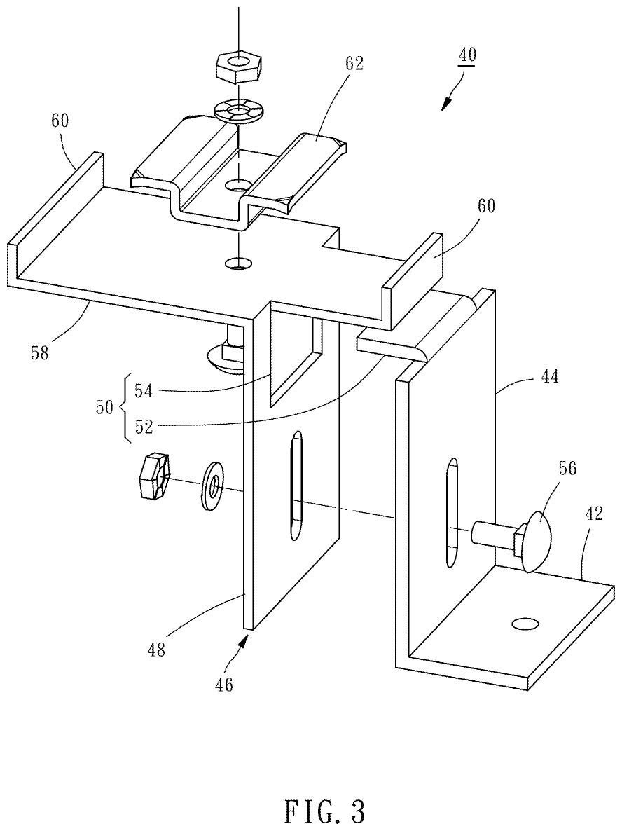

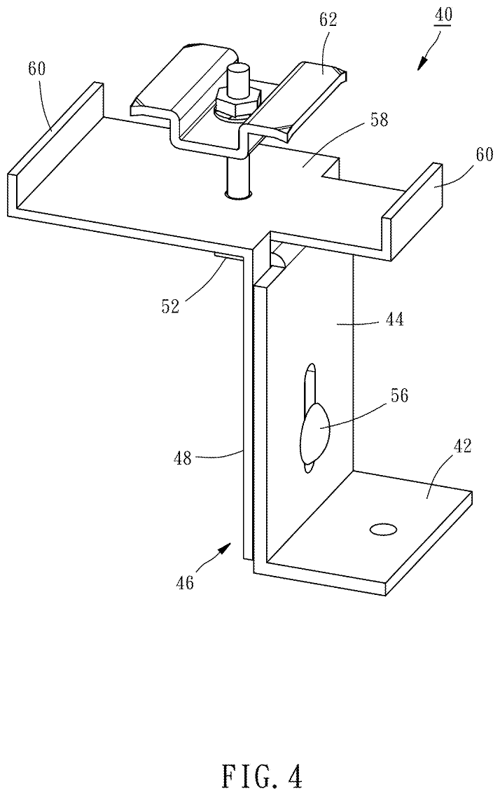

To cope with various different types of truss structure, as shown in FIG. 3 and FIG. 4, according to another preferred embodiment of an assembly apparatus 40 for a truss structure, its technical feature relies in that an engagement set 50 arranged between the attachment portion 44 of the supporting column 42 and the positioning portion 48 of the holding member 46 comprises an extension portion 52 arranged on the top side of the attachment portion 44 and a through hole 54 formed on the positioning portion 48 as an example for illustration. The assembly of the attachment portion 44 of the supporting column 42 and the positioning portion 48 of the holding member 46 with each other can also utilize the extension portion 52 to penetrate into the through hole 54 in order to guide the supporting column 42 and the holding member 46 to be positioned at the correct positions, such that there is no need for additional operating time to directly secure the fastening member 56. Furthermore, the supporting portion 58 of the holding member 46 is a flat plate horizontally extending at two opposite sides on top end of the positioning portion 48. The two ends of the supporting portion 58 respectively include a retaining portion 60 arranged thereon, and with a fixation member 62 cooperatively arranged approximately at a top central position of the supporting portion 58, it is able to allow the truss structure to be installed and secured on two sides of the supporting portion 58.

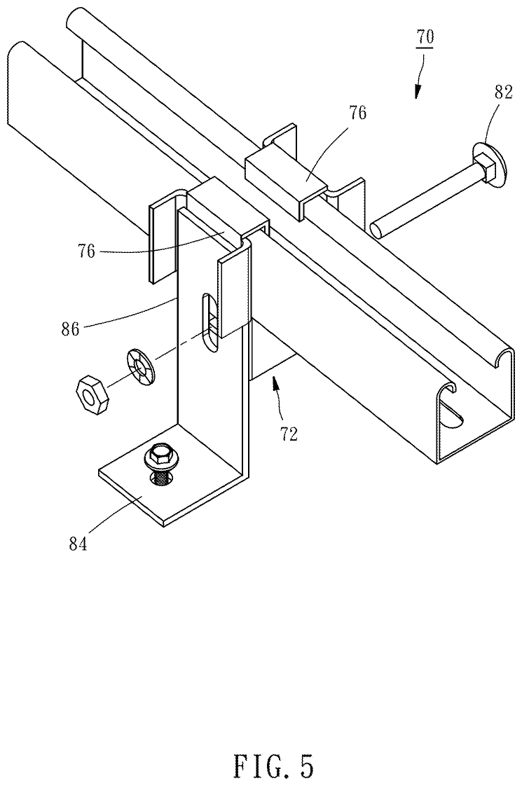

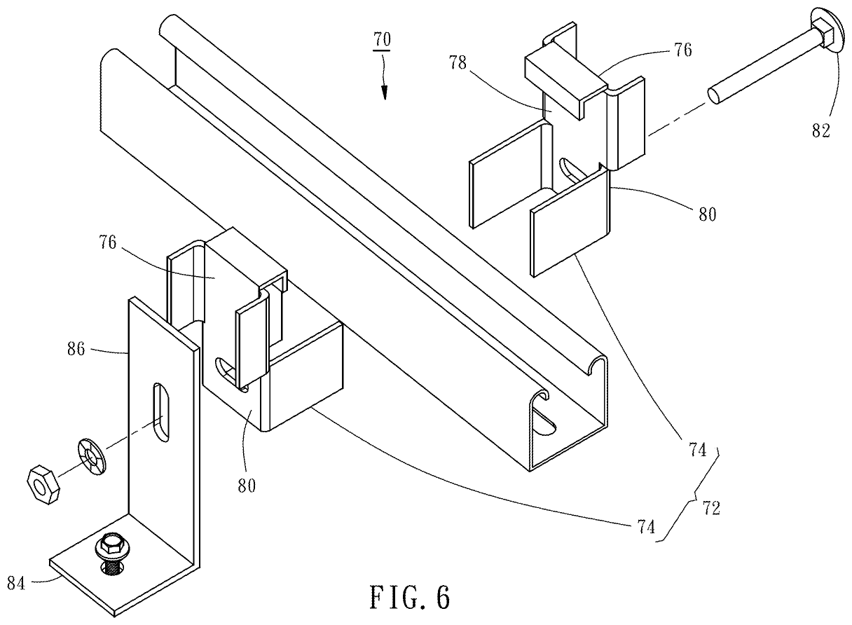

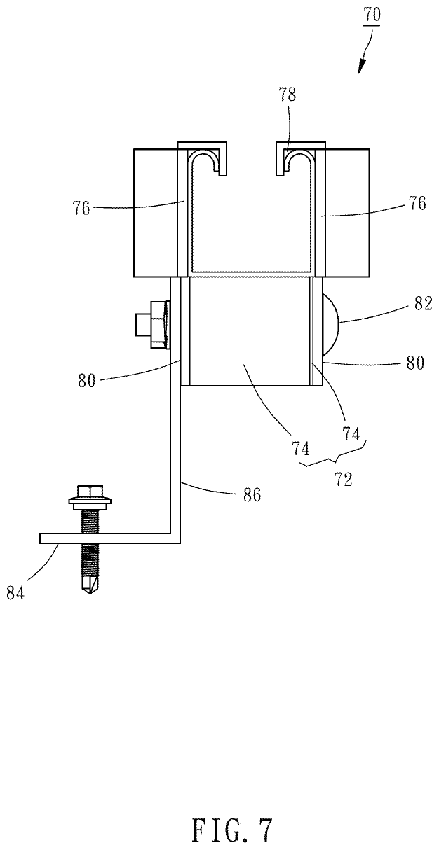

Furthermore, as shown FIG. 5 to FIG. 7, according to another preferred embodiment of the present invention, an assembly apparatus 70 for a truss structure is provided, and its technical feature relies in that the holding member 72 comprises two locking members 74. Each locking member 74 includes a supporting portion 76 arranged corresponding to each other in order to jointly form a guiding slot 78 thereon. The positioning portions 80 of the locking member 74 are also attached onto each other correspondingly. One of the positioning portions 80 is used to attach onto the attachment portion 86 of the supporting column 84 together with the fastening member 82, thereby achieving the technical advantages and objectives of the present invention similarly.

What is claimed is:

1. An assembly apparatus for a truss structure, comprising:
a supporting column having an attachment portion;
a holding member having a supporting portion and a positioning portion arranged adjacent to the supporting portion; the supporting portion having a guiding slot opened in a vertical direction; the guiding slot configured to receive the trust structure therein; and
a fastening member arranged on the positioning portion of the holding member and the attachment portion of the supporting column; the holding member movably secured onto the supporting column.

2. The assembly apparatus for a truss structure according to claim 1, wherein the supporting column includes a fixation portion; the attachment portion extends from the fixation portion in a vertical direction; the attachment portion includes an elongated through hole, and the fastening member is arranged at the through hole and the positioning portion.

3. The assembly apparatus for a truss structure according to claim 1, wherein the supporting column includes at least two retaining portions; the guiding slot is formed between the at least two retaining portions.

4. The assembly apparatus for a truss structure according to claim 1, wherein an engagement set is arranged between the attachment portion of the supporting column and the positioning portion of the holding member; the engagement set is positioned at the attachment portion of the supporting column and the positioning portion of the holding member.

5. The assembly apparatus for a truss structure according to claim 1, wherein the supporting portion of the holding member extends horizontally at two opposite sides of the positioning portion; the supporting portion includes at least two retaining portions to form the guiding slot, thereby allowing two sides of the supporting portion to be installed and secured with the truss structure thereon.

6. The assembly apparatus for a truss structure according to claim 1, wherein the holding member comprises two locking members; the two locking members are arranged corresponding to each other in order to jointly form the supporting portion and the positioning portion.
